(19) United States
(12) Patent Application Publication
(10) Pub. No.: US 2023/0208938 A1
(43) Pub. Date: Jun. 29, 2023

(54) ORCHESTRATING EXECUTION OF A COMPLEX COMPUTATIONAL OPERATION

(71) Applicant: Telefonaktiebolaget LM Ericsson (publ), Stockholm (SE)

(72) Inventors: Hiroshi DOYU, Espoo (FI); Miljenko OPSENICA, Espoo (FI); Edgar RAMOS, Kirkkonummi (FI); Jaime JIMÉNEZ, Espoo (FI)

(73) Assignee: Telefonaktiebolaget LM Ericsson (publ), Stockholm (SE)

(21) Appl. No.: 17/996,290

(22) PCT Filed: Apr. 15, 2020
(86) PCT No.: PCT/EP2020/060574

§ 371 Date: Oct. 14, 2022

(51) Int. Cl. H04L 67/60; H04L 67/125; G06F 9/50

(52) U.S. Cl. CPC H04L 67/60; G06F 9/5066; H04L 67/125

(57) ABSTRACT

A method (100) for orchestrating execution of a complex computational operation by at least one computing node is disclosed, wherein the complex computational operation can be decomposed into a plurality of component computational operations. The method, performed by an orchestration node, comprises discovering at least one computing node that has exposed, as a resource, a capability of the computing node to execute at least one component computational operation of the plurality of component operations (110). The method further comprises, for each component computational operation of the complex computational operation, selecting a discovered computing node for execution of the component computational operation (120), and sending a request message to each selected computing node requesting the selected computing node execute the component computational operation for which it has been selected (130). The method further comprises checking for a response to each sent request message (140).

### TECHNICAL FIELD

The present disclosure relates to an orchestration node that is operable to orchestrate execution of a complex computational operation by at least one computing node, a computing node that is operable to execute at least one component computational operation, a method for orchestrating execution of a complex computational operation by at least one computing node, the method being performed by an orchestration node, a method for operating a computing node that is operable to execute at least one component computational operation the method being performed by the computing node, a corresponding computer program, a corresponding carrier, and a corresponding computer program product.

### BACKGROUND

Machine Learning (ML) is the use of algorithms and statistical models to perform a task. ML generally involves two distinct phases: a training phase, in which algorithms build a mathematical model based on some sample input data, and an inference phase, in which the mathematical model is used to make predictions or decisions without being explicitly programmed to perform the task.

ML Libraries are sets of routines and functions that are written in a given programming language, allowing for the expression of complex computational operations without having to rewrite extensive amounts of code. ML libraries are frequently associated with appropriate interfaces and development tools to form a framework or platform for the development of ML models. Examples of ML libraries include PyTorch, TensorFlow, MXNet, Caffe, etc. ML libraries usually use their own internal data structures to represent calculations, and multiple different data structures may be suitable for each ML technique. These structures are usually expressed by Domain Specific Languages (DSL) or native Intermediate Representations (IR) specific to a library.

Owing to differences between model training and execution environments, it is important for performance and interoperability to be able to develop ML algorithms using one ML library, and then execute or improve such algorithms using another ML library. In this manner, the training phase for a particular model can be performed using one tool, and the model may then be deployed using a different tool. This interoperability requires the provision of a common standardized IR for representing ML models. An example of such an IR is the Open Neural Network Exchange (ONNX), first published in 2017 and available at https://github.com/onnx/onnx and https://onnx.ai/.

ONNX provides an open source format for an extensible computation graph model, as well as definitions of built-in operators and standard data types. These elements may be used to represent ML models developed using different ML libraries. Each ONNX computational graph is structured as a list of nodes, which are software concepts that can have one or more inputs and one or more outputs. Each node contains a call to the relevant primitive operations, referred to as “operators”. The graph also includes metadata for documentation purposes, usually in human readable form. The operators employed by a computational graph are implemented externally to the graph, but the set of built-in operators is the same across frameworks. Every framework supporting ONNX as an IR will provide implementations of these operators on the applicable data types. In addition to acting as an IR, ONNX also supports native running of ML models.

Orchestration of ML models is currently performed by a single orchestrator node. In the case of a model represented using ONNX, the ONNX computation graph is loaded on a machine and used as explained above. The orchestration is mainly performed at the micro-services level, and the nodes that are orchestrated must include a resource control component that enables control from the main orchestrator. The possibility exists to orchestrate ML models on distributed deployments, but this requires a very good knowledge of the capabilities and states of the nodes that are being orchestrated. Such knowledge implies a strictly hierarchical orchestration process, and requires assignment of specific roles, as well as extensive preparation before orchestration, including onboarding the nodes to be used and specifying their relationship in the orchestration framework.

When considering ML orchestration of constrained devices, that is devices in which power, memory, and/or processing resources are subject to limitations, the inclusion of a resource control component is challenging. The necessary overhead for such a component may be incompatible with the processing, memory and storage limitations of the constrained device. Orchestration possibilities for constrained devices are therefore limited to unikernels or firmware updates only, and cannot be fully under the control of a main orchestrator.

Another issue to be addressed when considering ML orchestration for constrained devices is node capabilities. The limitations present in constrained deployments mean it is highly unlikely that a constrained node would be capable of supporting the full range of operations and functions which may be required by ML algorithm implementations.

TinyML is an approach to integration of ML in constrained devices, and enables provision of a solution implementation in a constrained device that uses only what is required by a particular ML model, so reducing the requirements in terms of quantity of code and support for libraries and systems. An overview of the TinyML concept, focussed on the use of TensorFlow Lite, is provided in the book “TinyML” by Pete Warden and Daniel Situnayake, published in December 2019 by O′Reilly Media, Inc., ISBN: 9781492052036. TinyML offers solutions to ML implementation in constrained devices. However, the use of constrained oriented tools like TinyML requires, in most of cases, a firmware update in the device, which is a relatively heavy procedure and includes some risk of failure that could disable the device. It is desirable to perform firmware updates as infrequently as possible, and this limits the flexibility of a given device to execute different types of models to only those operators that are available in the current execution environment firmware of the device. The operators or ML functions that a device may support in a given execution environment are not specified by any specific standard, and they may vary considerably from one device to another, and from one ML framework to another.

### SUMMARY

It is an aim of the present disclosure to provide nodes, methods and a computer readable medium which at least partially address one or more of the challenges discussed above.

According to a first aspect of the present disclosure, there is provided an orchestration node that is operable to orchestrate execution of a complex computational operation by at least one computing node, which complex computational operation can be decomposed into a plurality of component computational operations. The orchestration node comprises processing circuitry that is configured to discover at least one computing node that has exposed, as a resource, a capability of the computing node to execute at least one component computational operation of the plurality of component operations. The processing circuitry is further configured, for each component computational operation of the complex computational operation, to select a discovered computing node for execution of the component computational operation and to send a request message to each selected computing node requesting the selected computing node execute the component computational operation for which it has been selected. The processing circuitry is further configured to check for a response to each sent request message.

According to another aspect of the present disclosure, there is provided a computing node that is operable to execute at least one component computational operation. The computing node comprises processing circuitry that is configured to expose, as a resource, a capability of the computing node to execute the at least one component computational operation. The processing circuitry is further configured to receive a request message from an orchestration node, the request message requesting the computing node execute a component computational operation. The processing circuitry is further configured to determine whether execution of the requested component computational operation is compatible with an operating policy of the computing node, and to send a response message to the orchestration node.

According to another aspect of the present disclosure, there is provided a method for orchestrating execution of a complex computational operation by at least one computing node, wherein the complex computational operation can be decomposed into a plurality of component computational operations. The method, performed by an orchestration node, comprises discovering at least one computing node that has exposed, as a resource, a capability of the computing node to execute at least one component computational operation of the plurality of component operations. The method further comprises, for each component computational operation of the complex computational operation, selecting a discovered computing node for execution of the component computational operation and sending a request message to each selected computing node requesting the selected computing node execute the component computational operation for which it has been selected. The method further comprises checking for a response to each sent request message.

According to another aspect of the present disclosure, there is provided a method for operating a computing node that is operable to execute at least one component computational operation. The method, performed by the computing node, comprises exposing, as a resource, a capability of the computing node to execute the at least one component computational operation. The method further comprises receiving a request message from an orchestration node, the request message requesting the computing node execute a component computational operation and determining whether execution of the requested component computational operation is compatible with an operating policy of the computing node. The method further comprises sending a response message to the orchestration node.

According to another aspect of the present disclosure, there is provided a computer program comprising instructions which, when executed on at least one processor, cause the at least one processor to carry out a method according to any one of the aspects or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

### BRIEF DESCRIPTION OF THE DRAWINGS

For a better understanding of the present disclosure, and to show more clearly how it may be carried into effect, reference will now be made, by way of example, to the following drawings in which:

FIG. 1 is a flow chart illustrating process steps in a method for orchestrating execution of a complex computational operation by at least one computing node;

FIGS. 2a to 2c show a flow chart illustrating process steps in another example of method for orchestrating execution of a complex computational operation by at least one computing node;

FIG. 3 is a flow chart illustrating process steps in a method for operating a computing node;

FIGS. 4a and 4b show a flow chart illustrating process steps in another example of method for operating a computing node;

FIG. 5 illustrates interactions to distribute machine learning tasks among devices

FIG. 6 is a state diagram for a computing node;

FIG. 7 is a state diagram for an orchestration node;

FIG. 8 is a block diagram illustrating functional modules in an orchestration node; and

FIG. 9 is a block diagram illustrating functional modules in a computing node.

### DETAILED DESCRIPTION

Aspects of the present disclosure provide nodes and methods that enable the exposure and negotiation of computational capabilities of a device, in order to use those capabilities as RESTful computational elements in the distributed orchestration of a complex computational operation. The device may in some examples be a constrained device, as set out in IETF RFC 7228 and discussed in further detail below. According to examples of the present disclosure, resource and computing orchestration routines and guidance for constrained devices may be exchanged via a lightweight protocol. This is in contrast to the existing approach of seeking to realise orchestration routines directly in devices that frequently cannot support the additional requirements of such routines, and may also have connectivity constraints. Devices, also referred to in the present disclosure as nodes or endpoints, that are capable of performing computational operations can expose this capability in the form of resources, which can be registered and discovered. The role of orchestrator can be arbitrarily assigned to any node having the processing resources to carry out the orchestration method.

As noted above, the computational capabilities of devices may be exposed, according to examples of the present disclosure, as RESTful resources. Such resources are part of the Representational State Transfer (REST) architectural design for applications, a brief discussion of which is provided below.

REST seeks to incrementally impose limitations, or constrains, on an initial blank slate system. It first separates entities into clients and servers, depending on whether or not an entity is hosting information, and then adds limitations on the amount of state that a server should keep, ideally none. REST then adds constrains on the cacheability of messages, and defines some specific verbs or “methods” for interaction with information, which may be found at specific locations on the Internet expressed by Uniform Resource Identifiers (URls). REST deals with information in the form of several data elements as follows:
Resources, which are the conceptual target of a reference and are hosted on a server;
Resource identifiers such as Uniform Resource Locations (URLs), and Uniform Resource Names (URNs);
Representations such as a JPEG image, a SenML blob, or an HTML document;
Representation metadata including media type or content type;
Resource metadata such as source link or alternates; and
Control data including cache-control, if-modified etc.

Transfer protocols such as the Hypertext Transfer Protocol (HTTP) and Constrained Application Protocol (CoAP), which is based on HTTP and targets constrained environments as discussed in further detail below, were developed as a consequence of the REST architectural design and the REST architectural elements. In enabling the expose of computational capabilities of a node in the form of resources, examples of the present disclosure may leverage the functionality of such RESTful protocols to facilitate orchestration of complex computational operations, such as ML models, on devices without requiring the presence of a resource control component in the devices. The role of orchestrator may be assigned to any device having suitable processing capabilities and connectivity.

A description of methods that may be carried out by an orchestration node and a computing node according to different examples of the present disclosure is presented below. The description includes discussion of details which may be incorporated in different implementations of these examples. There then follows a discussion of implementation examples of such methods, in particular with reference to an implementation in which the nodes are CoAP endpoints, and in which the complex computational operation to be orchestrated is represented using the ONNX data format.

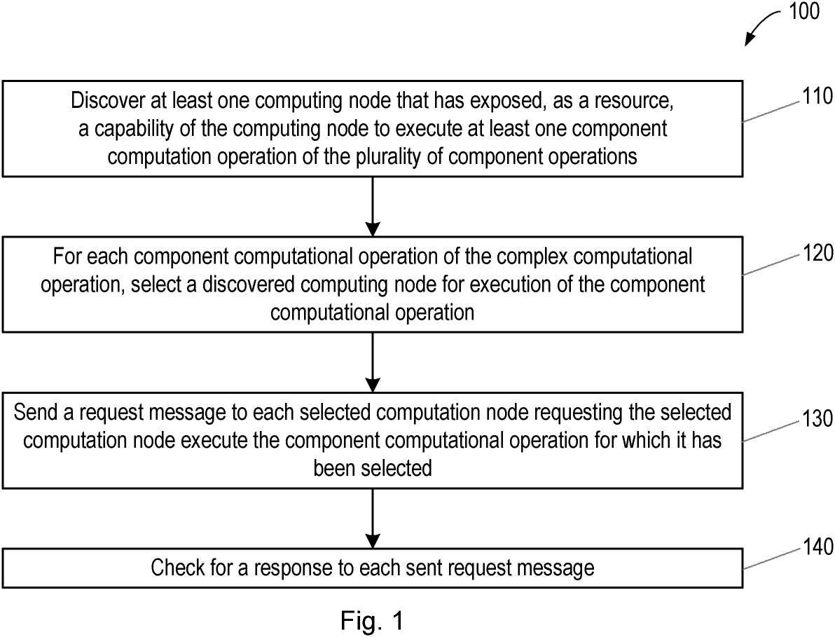

FIG. 1 is a flow chart illustrating process steps in a method 100 for orchestrating execution of a complex computational operation by at least one computing node. The method is performed by an orchestration node, which may be a physical node such as a computing device, server etc., or may be a virtual node, which may comprise any logical entity, for example running in a cloud, edge cloud or fog deployment. The orchestration node may be operable to run a CoAP client, and may therefore comprise a CoAP endpoint, that is a node which is operable in use to run a CoAP server and/or client. The computing node may also be a physical or virtual node, and may comprise a CoAP endpoint operable to run a CoAP server. The computing node may in some examples comprise a constrained device.

The complex computational operation to be orchestrated can be decomposed into a plurality of component computational operations, which may comprise primitive computational operations or may comprise combinations of one or more primitive computational operations. The complex computational operation may for example comprise an ML model, or a chain of ML models.

Referring to FIG. 1, the method 100 first comprises, in step 110, discovering at least one computing node that has exposed, as a resource, a capability of the computing node to execute at least one component computational operation of the plurality of component operations. The method then comprises, in step 120, for each component computational operation of the complex computational operation, selecting a discovered computing node for execution of the component computational operation, and, in step 130, sending a request message to each selected computing node requesting the selected computing node execute the component computational operation for which it has been selected. In step 140, the method 100 comprises checking for a response to each sent request message.

According to examples of the present disclosure, the capability of a computing node to execute at least one component computational operation may comprise a computation operator (ADD, OR etc.) as defined in any appropriate data format, for example corresponding to one or more ML learning libraries or Intermediate Representations (IR). Execution of a specific component computational operation comprises the application of such an operator to specific input data. Thus a computing node may expose computation operators (capabilities) as resources, and an orchestration node may request execution of specific component computational operations using the computation operators exposed by computing nodes.

The execution of the component computational operations requested by the orchestration node in the message sent at step 130 may comprise a collaborative execution between multiple computing nodes, each of which may perform one or more of the component computational operations of the complex computational operation. For example, the collaborative execution may comprise exchange of one or more inputs or outputs between nodes, as the result of a component computational operation executed by one computing node is provided to another computing node as an input to a further component computational operation. In further examples, some or all computing nodes may return the results of their component computational operation to the orchestration node only. In still further examples, a single computing node may be selected to execute all of the component computational operations of the complex computational operation.

As discussed above, according to examples of the present disclosure, the computing node may comprise a constrained device. For the purposes of the present disclosure, a constrained device comprises a device which conforms to the definition set out in section 2.1 of IETF RFC 7228 for “constrained node”. According to the definition in IETF RFC 7228, a constrained device is a device in which “some of the characteristics that are otherwise pretty much taken for granted for Internet nodes at the time of writing are not attainable, often due to cost constraints and/or physical constraints on characteristics such as size, weight, and available power and energy. The tight limits on power, memory, and processing resources lead to hard upper bounds on state, code space, and processing cycles, making optimization of energy and network bandwidth usage a dominating consideration in all design requirements. Also, some layer-2 services such as full connectivity and broadcast/multicast may be lacking”.

Constrained devices are thus clearly distinguished from server systems, desktop, laptop or tablet computers and powerful mobile devices such as smartphones. A constrained device may for example comprise a Machine Type Communication device, a battery powered device or any other device having the above discussed limitations. Examples of constrained devices may include sensors measuring temperature, humidity and gas content, for example within a room or while goods are transported and stored, motion sensors for controlling light bulbs, sensors measuring light that can be used to control shutters, heart rate monitors and other sensors for personal health (continuous monitoring of blood pressure etc.) actuators and connected electronic door locks. IoT devices may comprise examples of constrained devices.

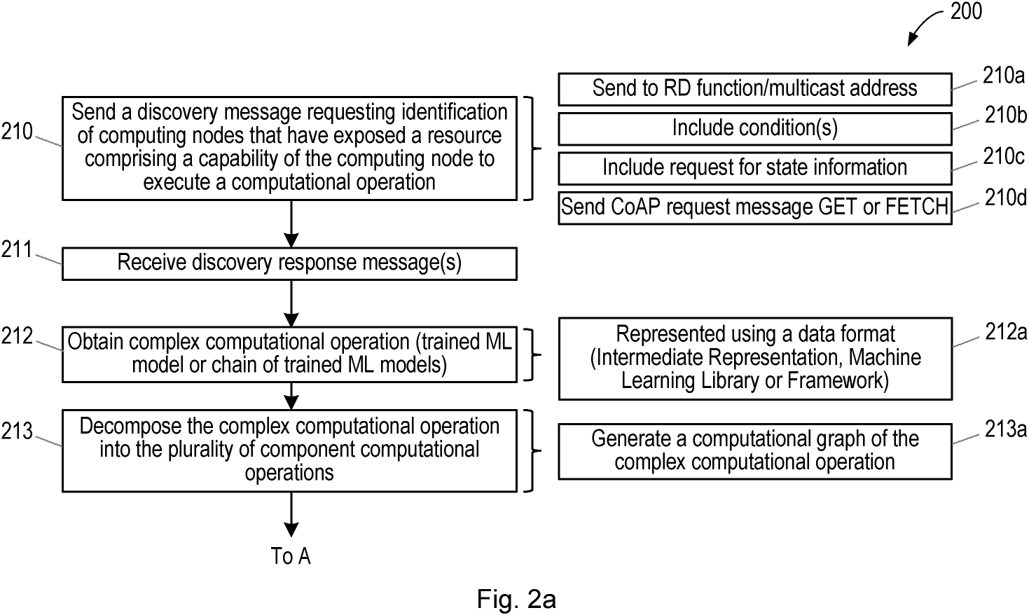

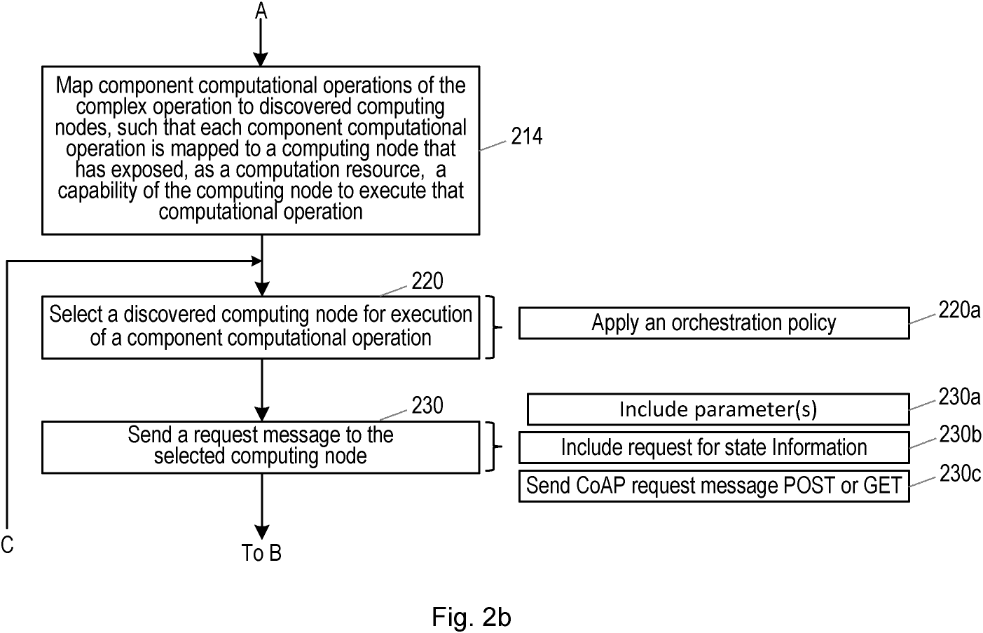

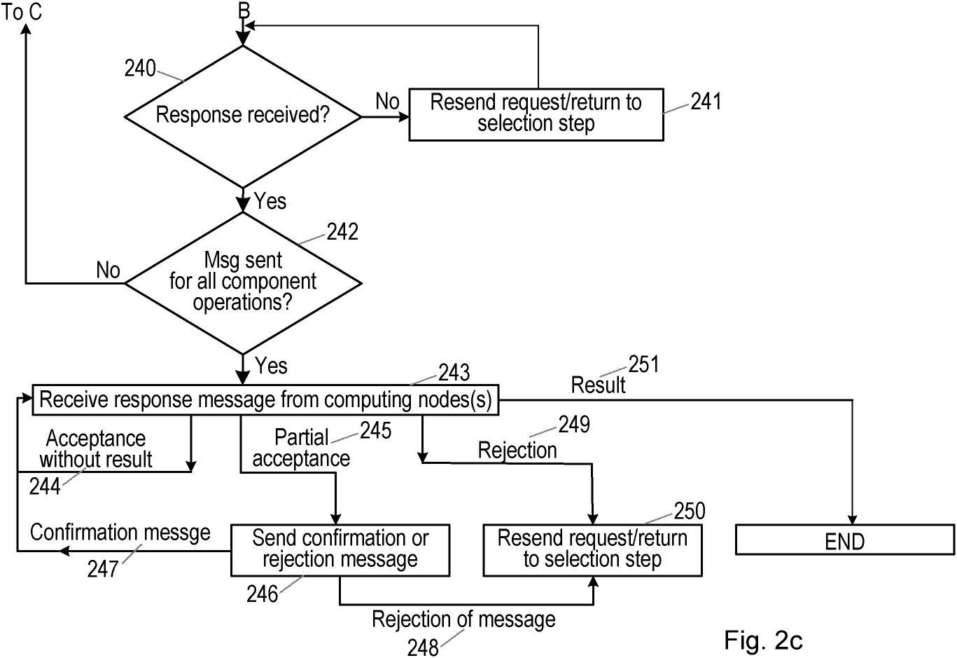

FIGS. 2a to 2c show a flow chart illustrating process steps in a further example of method 200 for orchestrating execution of a complex computational operation by at least one computing node. The method 200, as for the method 100, is performed by an orchestration node, which may be a physical or a virtual node, and may comprise a CoAP endpoint operable to run a CoAP client, as discussed above with reference to FIG. 1. Also as discussed above with reference to FIG. 1, the computing node may also be a physical or virtual node, and may comprise a CoAP endpoint operable to run a CoAP server. The computing node may in some examples comprise a constrained device.

The complex computational model to be orchestrated can be decomposed into a plurality of component computational operations, which may comprise primitive computational operations or may comprise combinations of one or more primitive computational operations. The complex computational operation may for example comprise an ML model, or a chain of ML models.

The steps of the method 200 illustrate one example way in which the steps of the method 100 may be implemented and supplemented in order to achieve the above discussed and additional functionality.

Referring first to FIG. 2a, according to the method 200, in a first step 210, the orchestration node sends a discovery message requesting identification of computing nodes that have exposed a resource comprising a capability of the computing node to execute a computational operation. In some examples, the discovery message may request identification of computing nodes exposing specific resources, for example resources comprising the capability to execute the specific component computational operations into which the complex computational operation to be orchestrated may be decomposed. This may be achieved for example by requesting identification of computing nodes exposing resources having a specific resource type, the resource type corresponding to a specific computational capability or operator. In other examples, the discovery message may request identification of computing nodes exposing any resources comprising a computational capability, for example by requesting identification of computing nodes exposing resources having a content type that is consistent with such resources.

As illustrated at 210a, the discovery message may be sent to at least one of a Resource Directory (RD) function, or a multicast address for computing nodes. As illustrated at 210b, the discovery message may include at least one condition to be fulfilled by computing nodes in addition to having exposed a resource comprising a capability of the computing node to execute a component computational operation. The condition may relate to the state of the computing node, for example battery life, CPU usage etc., and may be selected by the orchestration node in accordance with an orchestration policy, as discussed in further detail below. As illustrated at 210c, the discovery message may also or alternatively include a request for information about a state of the computing nodes, such as CPU load, memory load, I/O computational operation rates, connectivity bitrate etc. This information may be used by the orchestration node to select a computing node for a particular component computational operation, as discussed in further detail below. As illustrated at 210d, in the case of an orchestration node and computing nodes comprising CoAP endpoints, the discovery message may be sent as a CoAP GET REQUEST message or a CoAP FETCH REQUEST message. A CoAP request message is largely equivalent to an HTTP request message, and is sent by a CoAP client to request an action on a resource exposed by a CoAP server. The action is requested using a Method Code and the resource is identified using a URI. CoAP Method Codes are standardised for the methods: GET, POST, PUT, DELETE, PATCH and FETCH. A CoAP GET request message is therefore a CoAP request message including the field code for the GET method in the header of the message. According to examples of the present disclosure therefore, the CoAP GET and/or FETCH methods may be used to discover resources comprising capabilities to execute a component computational operation.

In step 211, the orchestration node receives one or more discovery response messages, either from the RD function or the computing nodes themselves.

The orchestration node may then obtain the complex computational operation to be orchestrated at step 212, for example an ML model or chain of ML models. As illustrated at 212a, the complex computational operation may be represented using a data format, and the resource or resources exposed by the discovered computing node or nodes may comprise a capability that is represented in the same data format. The data format may comprise at least one of a Machine Learning Library or an Intermediate Representation, including for example ONNX, TensorFlow, PyTorch, Caffe etc. The orchestration node may obtain the complex computational operation by generating the complex computational operation, or by receiving or being configured with the complex computational operation.

In some examples, the orchestration node may repeat the step of sending a discovery message after obtaining the complex computational operation, for example if some time has elapsed since a previous discovery operation, or if the orchestration node subsequently establishes that it has not discovered computing nodes having all of the required capabilities for the obtained complex computational operation.

In step 213, the orchestration node may decompose the complex computational operation into the plurality of component computational operations. As illustrated at 213a, decomposing the complex computational operation into a plurality of component computational operations may comprise generating a computation graph of the complex computational operation.

Referring now to FIG. 2b, the orchestration node may then, in step 214, map component computational operations of the complex computational operation to discovered computing nodes, such that each component computational operation is mapped to a computing node that has exposed, as a resource, a capability of the computing node to execute that computational operation. In other examples, (not shown), the mapping step 214 may be omitted, and the orchestration node may proceed directly to selection of discovered computing nodes for execution of component computational operations, without first mapping the entire complex computational operation to discovered computing nodes. Examples in which the mapping step is omitted may be appropriate for execution of the method 200 in orchestration nodes having limited processing power or memory.

The orchestration node then proceeds, for each component computational operation of the complex computational operation, to select a discovered computing node for execution of a component computational operation in step 220, and to send a request message to the selected computing node in step 230, the request message requesting that the selected computing node execute the component computational operation for which it has been selected. If the complex computational operation has been mapped in step 214, selecting computing nodes may comprise, for each component computational operation, selecting the computing node to which the component computational operation has been mapped.

The selection and sending of request messages may be performed sequentially for each component computational operation. The sequential selection and sending of request messages may be according to an order in which the complex computational operation may be executed (i.e. an order in which a computational graph of the complex computational operation may be traversed), or an order in which the component computational operations appear in the decomposed complex computational operation, or any other order. Thus, in examples in which the complex computational operation has not been mapped, the orchestration node may simply start with a first decomposed component computational operation, or a first component computational operation of a computation graph of the complex computational operation, and work through the complex computational operation sequentially, selecting computing nodes and sending request messages.

As illustrated at 220a, the orchestration node may apply an orchestration policy in order to select a discovered computing node for execution of a component computational operation. The orchestration policy may distinguish between discovered computing nodes on the basis of at least one of information about a state of the discovered computing nodes, information about a runtime environment of the discovered computing nodes, or information about availability of the discovered computing nodes. For example, the orchestration node may prioritise selection of computing nodes having space processing capacity (CPU usage below a threshold level etc.), or that are available at a desired scheduling time for execution of the complex computational operation. The orchestration node may seek to balance the demands placed on the computing nodes with an importance or priority of the complex computational operation to be orchestrated.

As illustrated at 230a, the orchestration node may include with the request message sent to a selected computing node at least one request parameter applicable to execution of the component computational operation for which the node has been selected. The request parameter may comprise at least one of a required output characteristic of the component computational operation, an input characteristic of the component computational operation, or a scheduling parameter for the component computational operation. The required output characteristic may comprise a required output throughput. The scheduling parameter may for example comprise “immediately”, “on demand” or may comprise a specific time or time window for execution of the identified computational operation. The request parameters may be considered by the computing node in determining whether or not the computing node can execute the requested operation.

As illustrated at 230b, the orchestration node may additionally or alternatively include with the request message sent to a selected computing node a request for information about a state of the selected computing node, for example if such information was not requested at discovery, or if the information provided at discovery may now be out of date. The state information may comprise CPU load, memory load, I/O computational operation rates, connectivity bitrate etc. As illustrated at 230c, and discussed in further detail below, in examples in which the orchestration and computing nodes comprise CoAP endpoints, the orchestration node may send the request message by sending a CoAP POST REQUEST message, a CoAP PUT REQUEST message or a CoAP GET REQUEST message. The CoAP POST or PUT methods may therefore be used to request a computing node execute a component computational operation. The CoAP GET method may be used to request the result of a previously executed component computational operation, as discussed in greater detail below.

Referring now to FIG. 2c, the orchestration node then checks, at step 240, whether or not a response has been received to a sent request message. If no response has been received to a particular request message, the orchestration node may, at step 241 and after a response time interval, either resend the request message to the selected computing node after a resend interval, or select a new discovered computing node for execution of the component computational operation and send a request message to the new selected computing node requesting the new selected computing node execute the component computational operation for which it has been selected.

If a response message has been received to a particular request message, the orchestration node may then check whether a request message has been sent for all component computational operations of the complex computational operation at step 424. If a request message has not yet been sent for all component computational operations, the orchestration node returns to step 220. If a request message has been sent for all component computational operations, the orchestration node proceeds to step 243.

It will be appreciated that the orchestration node may organise the sequential selection and sending of request messages, and the checking for response messages and appropriate processing, in any suitable order. For example, the orchestration node may select and send request messages for all component computational operations of the complex computational operation before starting to check for response messages (arrangement not illustrated), or, as illustrated in FIG. 2c, may check for a response to a request message and perform appropriate processing before proceeding to the select a computing node for the next component computational operation. Thus while the processing of response messages is discussed below as taking place after request messages have been sent for all component computational operations of the complex computational operation, it will be appreciated that in some examples, at least some of the processing of response messages for component computational operations considered earlier in the process may be carried out substantially in parallel with the selection of computing nodes and sending of request messages for component computational operations considered later in the process.

At step 243, the orchestration node receives a response message from a computing node. The response message may comprise control signalling, and may for example comprise acceptance of a requested execution of a component computational operation, which acceptance may in some cases be partial or conditional, or rejection of a requested execution of a component computational operation. In some examples, data signalling may also be included, and the response message may for example comprise a result of a requested execution of a component computational operation. This may be appropriate for example if the request message requested immediate execution of the component computational operation, and if the computing node was able to carry out the request. In other examples, the request message may have requested scheduled execution of the component computational operation, and the computing node may send an acceptance message followed, at a later time, by a message including the result of the requested component computational operation.

As illustrated at 244, if the received response message comprises an acceptance without a result of the requested component computational operation, the orchestration node may then wait to receive another response message from the computing node, which response message comprises the result. As illustrated at 251, if the received response message comprises the result of the requested component computational operation, then the processing for that component computational operation is complete, and the orchestration node may end the method, await further response messages relating to other requested computational operations, perform additional processing relating to a result of the component computational operation that has been orchestrated, etc.

As illustrated at 245, the response message received at step 243 may comprise a partial acceptance of the request to execute a component computational operation. The partial acceptance may comprise at least one of acceptance of the requested execution of the component computational operation that is conditional upon at least one criterion specified by the selected computing node, or acceptance of the requested execution of the component computational operation that indicates that the selected computing node cannot fully comply with at least one request parameter included with the request message. For example, the request may have specified immediate execution of the requested component computational operation, and the computing node may only be able to execute the requested component computational operation within a specific timeframe, according to its own internal policy for making resources available to other nodes. The orchestration node may, in response to a partial acceptance of a requested execution of a component computational operation, perform at step 246 at least one of sending a confirmation message maintaining the request to execute the component computational operation or sending a rejection message revoking the request to execute the component computational operation. If the orchestration node sends a confirmation message, as illustrated at 247, then it may await a further response message from the computing node that includes the result of the component computational operation. If the orchestration node sends a rejection message, as illustrated at step 248, then the orchestration node may then, at step 250, perform at least one of resending the request message to the selected computing node after a time interval, or selecting a new discovered computing node for execution of the component computational operation and sending a request message to the new selected computing node requesting the new selected computing node execute the component computational operation for which it has been selected. The actions at step 250 may also be performed if the response message received in step 243 is a rejection response from the computing node, as illustrated at 249. A rejection response may be received for example if the computing node is unable to execute the requested component computational operation, is unable to comply with the request parameters, or if to do so would be contrary to the computing node’s own internal policy.

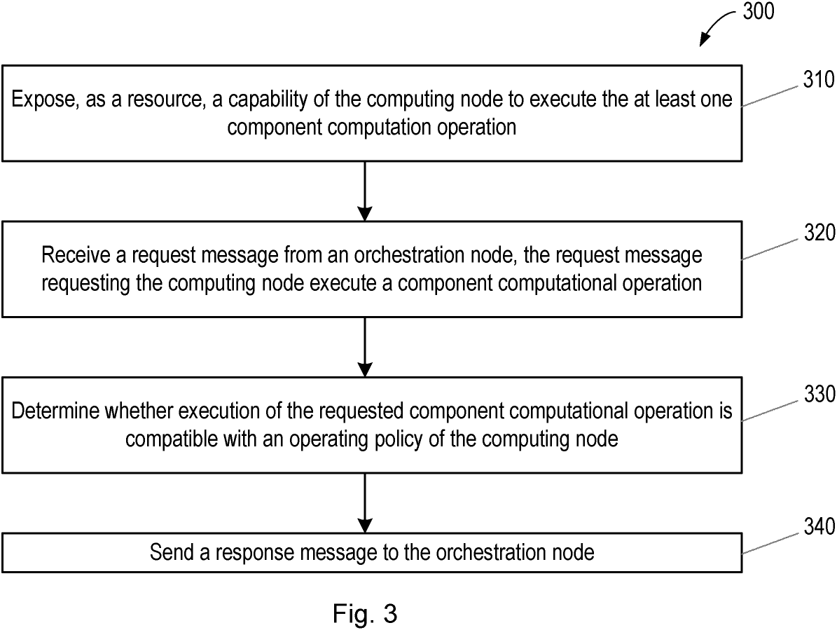

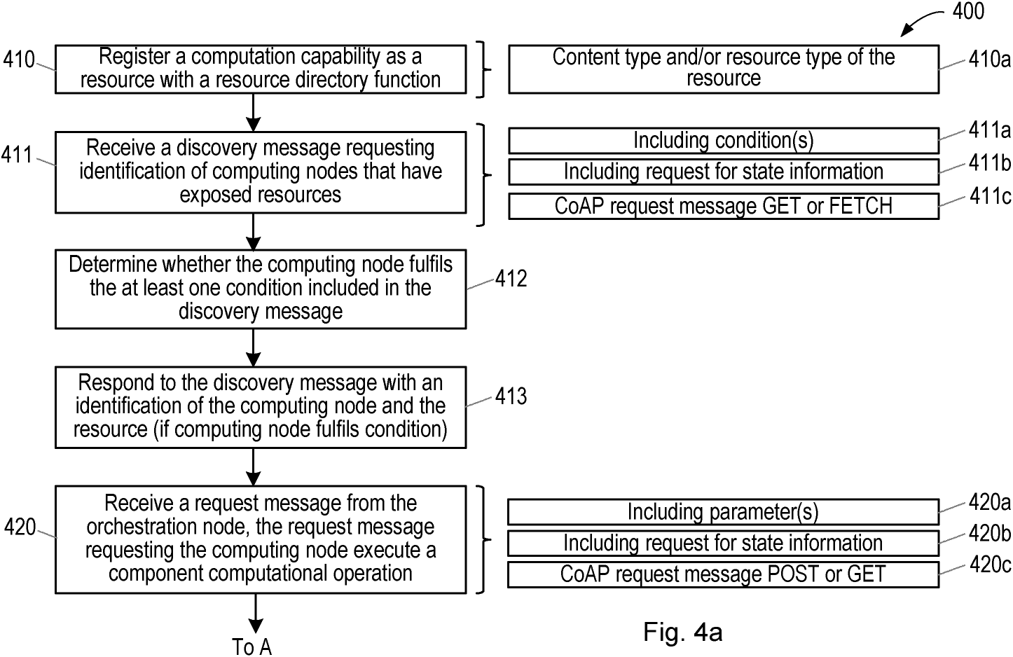

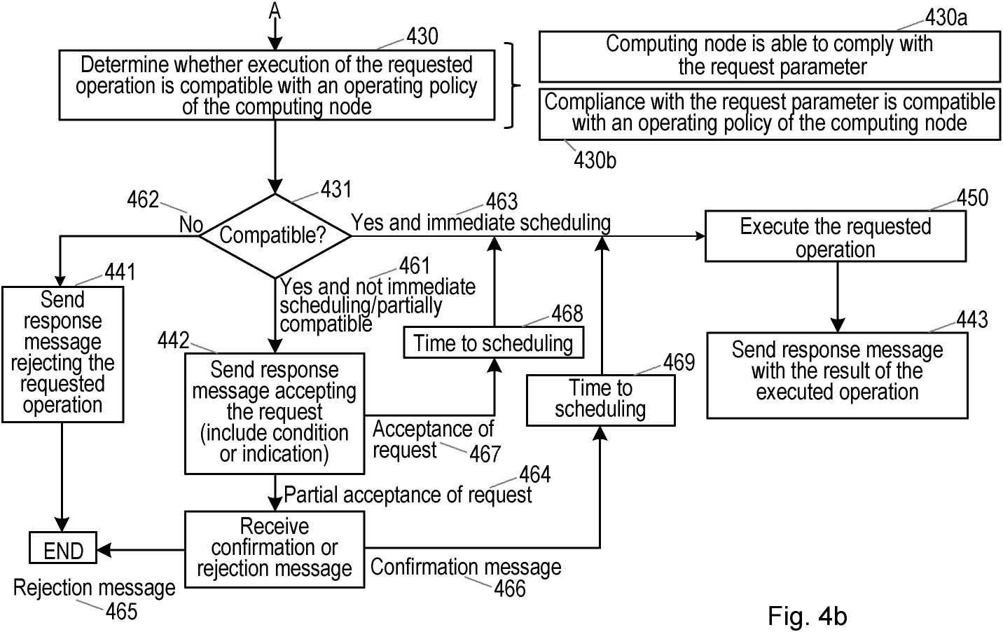

FIGS. 2a to 2c thus illustrate one way in which an orchestration node may orchestrate execution of a complex computational operation, such as an ML model, by discovering computing nodes exposing appropriate computational capabilities as resources, decomposing the complex computational operation, and sequentially selecting computing nodes for execution of component computational operations and sending suitable request messages. The methods 100 and 200 of FIGS. 1 and 2a to 2c may be complimented by suitable methods performed at one or more computing nodes, as illustrated in FIGS. 3, 4a and 4b.

FIG. 3 is a flow chart illustrating process steps in a method 300 for operating a computing node. The method is performed by the computing node, which may be a physical node such as a computing device, server etc., or may be a virtual node, which may comprise any logical entity, for example running in a cloud, edge cloud or fog deployment. The computing node may be operable to run a CoAP server, and may therefore comprise a CoAP endpoint, that is a node which is operable in use to run a CoAP server and/or client. The computing node may in some examples comprise a constrained device, as described above with reference to FIG. 1. The computing node is operable to execute at least one component computational operation. The component computational operation may comprise a primitive computational operation (ADD, OR, etc.) or may comprise a combination of one or more primitive computational operations.

Referring to FIG. 1, the method 300 first comprises, in a first step 310, exposing, as a resource, a capability of the computing node to execute the at least one component computational operation. In step 320, the method comprises receiving a request message from an orchestration node, the request message requesting the computing node execute a component computational operation. The request message may for example include an identification of the capability exposed as a resource together with one or more inputs for the requested component computational operation. The orchestration node may be a physical or virtual node, and may comprise a CoAP endpoint operable to run a CoAP client. At step 330, the method 300 comprises determining whether execution of the requested component computational operation is compatible with an operating policy of the computing node. Finally, at step 340, the method 300 comprises sending a response message to the orchestration node.

According to examples of the present disclosure, the capability of a computing node to execute at least one component computational operation may comprise a computation operator (ADD, OR etc.) as defined in any appropriate data format, for example corresponding to one or more ML learning libraries or Intermediate Representations. Execution of a specific component computational operation comprises the application of such an operator to specific input data, as may be included in the received request message.

In some examples, the execution of the component computational operation requested by the orchestration node in the message received at step 320 may comprise a collaborative execution between multiple computing nodes, each of which may perform one or more of the component computational operations of a complex computational operation orchestrated by the orchestration node. For example, the collaborative execution may comprise exchange of one or more inputs or outputs between computing nodes, as the result of a component computational operation executed by one computing node is provided to another computing node as an input to a further component computational operation. Instructions for such exchange may be included in the received request message. In further examples, the computing node may return the result of the requested component computational operation, if the request is accepted by the computing node, to the orchestration node only.

FIGS. 4a and 4b show a flow chart illustrating process steps in a further example of method 400 for operating a computing node. The method 400, as for the method 300, is performed by a computing node, which may be a physical or a virtual node, and may comprise a CoAP endpoint operable to run a CoAP server, as discussed above with reference to FIG. 3. The computing node may in some examples comprise a constrained device as discussed above with reference to FIG. 1.

The steps of the method 400 illustrate one example way in which the steps of the method 300 may be implemented and supplemented in order to achieve the above discussed and additional functionality.

Referring first to FIG. 4a, according to the method 400, in a first step 410, the computing node exposes the capability of the computing node to execute the at least one component computational operation by registering the capability as a resource with a resource directory function. As illustrated at 410a, the computing node may register at least one of a content type of the resource, the content type corresponding to resources comprising a capability to execute a component computational operation, or a resource type of the resource, the resource type corresponding to the particular capability. The computing node may register more than one capability to perform a component computational operation, and may additionally register other resources and characteristics.

The computing node may additionally or alternatively expose its capability to perform a component computational operation as a resource by receiving and responding to a discovery message, as set out in steps 411 to 413 and discussed below.

In step 411, the computing node may receive a discovery message requesting identification of computing nodes that have exposed a resource comprising a capability of the computing node to execute a component computational operation. The discovery message may request specific computation capability resources, for example by requesting resources having a specific resource type, or may request any computation capability resources, for example by requesting resources having a content type that is consistent with a capability to execute a component computational operation. The discovery message may be addressed to a multicast address for computing nodes. As illustrated at 411c, in examples in which the computing node comprises a CoAP endpoint, the discovery message may comprise a CoAP GET REQUEST message or a CoAP FETCH REQUEST message.

As illustrated at 411b, the discovery message may include a request for state information relating to the computing node (CPU usage, battery life etc.), and may also include one or more conditions, as illustrated at 411a. In step 412, the computing node determine whether the computing node fulfils the one or more conditions included in the discovery message. At step 413, if the computing node fulfils the one or more conditions, the computing node responds to the discovery message with an identification of the computing node and its capability, or capabilities, to execute a component computational operation. The computing node may include in the response to the discovery message the state information for the computing node that was requested in the discovery message.

In step 420, the computing node receives a request message from an orchestration node, the request message requesting the computing node execute a component computational operation. As discussed above with reference to FIG. 3, the orchestration node may be a physical or virtual node, and may comprise a CoAP endpoint operable to run a CoAP client. As illustrated at 420a, the request message may include at least one request parameter, such as for example a required output characteristic of the requested component computational operation, an input characteristic of the requested component computational operation, or a scheduling parameter for the requested component computational operation. A required output characteristic may comprise a required output throughput, and a scheduling parameter may for example comprise “immediately”, “on demand” or may comprise a specific time or time window for execution of the component computational operation. The request message may also or alternatively include a request for state information relating to the computing node (CPU usage, battery life etc.) as illustrated at 420b. As illustrated at 420c, in examples in which the computing node comprises a CoAP endpoint, the request message may comprise a CoAP POST REQUEST message, a CoAP PUT request message or a CoAP GET REQUEST message.

In examples in which the request message comprises a CoAP GET REQUEST message, the computing node may respond to the request message by sending to the orchestration node a result of the most recent execution of the requested component computational operation. In such examples, the computing node may then terminate the method, rather than proceeding to determine a compatibility of the request with its operating policy and execute the request. In this manner, the orchestration node may obtain a result of a last executed operation by the computing node, without causing the computing node to re-execute the operation.

Referring now to FIG. 4b, the computing node determines, at step 430, whether execution of the requested component computational operation is compatible with an operating policy of the computing node. This may comprise determining whether or not the computing node is able to comply with the request parameter at 430a, and/or whether or not compliance with one or more request parameters included in the request message is compatible with an operating policy of the computing node. For example, an operating policy of the computing node may specify the extent to which the computing node may make its resource available to other entities, including limitations on time, CPU load, battery life etc. The computing node may therefore determine, at step 430, whether its current state fulfils conditions in its policy for making its resources available to other nodes, and whether, for example a scheduling parameter in the request message is consistent with time limits on when its resources may be made available to other nodes etc.

If the request message includes a request for state information of the computing node, the computing node may include this information in its response to the orchestration node, as discussed below. Such information may include CPU load, memory load, I/O computational operation rates, connectivity bitrate etc.

If, at step 431, the computing node determines that execution of the requested component computational operation is not compatible with an operating policy of the computing node, the computing node sends a response message in step 441 that rejects the requested component computational operation, so terminating the method 400 with respect to the request message received in step 420. It will be appreciated that the computing node may receive a new discovery message or request message at a later time, and may therefore repeat appropriate steps of the method. In some examples, the computing node may receive at a later time a request from the same orchestration node to execute the same or a different component computational operation, and may process the request as set out above with respect to the current state of the computing node and the current time.

If, at step 431, the computing node determines that execution of the requested component computational operation is compatible with an operating policy of the computing node, subsequent processing may depend upon whether the request was fully or partially compatible with the operating policy, and whether the request was for immediate scheduling or for executing at a later scheduled time. If the request was determined to be fully compatible with the operating policy (i.e. all of the request parameters could be satisfied while respecting the operating policy), and the request was for immediate scheduling, as illustrated at 463, the computing node proceeds to execute the requested operation at step 450 and sends a response message in step 443, which response message includes the result of the executed component computational operation.

If the request was determined to be only partially compatible with the operating policy (i.e. not all of the request parameters could be satisfied while respecting the operating policy), and/or the request was not for immediate scheduling, as illustrated at 461, the computing node proceeds to send a response message accepting the request at step 442.

If the request was determined to be fully compatible with the operating policy (i.e. all of the request parameters could be satisfied while respecting the operating policy), but the request was not for immediate scheduling, as illustrated at 467, the computing node proceeds to wait until the scheduled time for execution has arrived at step 468, before proceeding to execute the requested operation at step 450 and sending a response message in step 443, which response message includes the result of the executed component computational operation.

If the request was determined to be only partially compatible with the operating policy, the response message sent at step 442 may indicate that acceptance of the request is conditional upon at least one criterion specified by the computing node, which criterion is included in the response message. The criterion may for example specify a scheduling time within which the computing node can execute the requested component computational operation, which scheduling time is different to that included in the request message, or may specify a scheduling window in response to a request for “on demand” scheduling. In another example, if the request was determined to be only partially compatible with the operating policy, the response message sent at step 442 may indicate that the computing node cannot fully comply with at least one request parameter included with the request message (for example required output throughput etc.). In such examples, in which only a partial acceptance of the request was sent in step 442, as illustrated at 464, the computing node then waits to receive from the orchestration node in step 465 either a confirmation message maintaining the request to execute the computational operation or a rejection message revoking the request to execute the computational operation.

If the computing node receives a rejection message, as illustrated at 465, this revokes or cancels he request received in step 420, and the computing node terminates the method 400 with reference to that request message. If the computing node receives a confirmation message, as illustrated at 466, this conveys that the indication or condition sent at step 442 is accepted by the orchestration node, and the request received at step 420 is maintained. The computing node then proceeds to wait until the scheduled time for execution has arrived at step 469, before proceeding to execute the requested operation at step 450 and sending a response message in step 443, which response message includes the result of the executed component computational operation.

The method 400, or method 300, carried out by a computing node, thus enables a computing node that has a capability to execute a component computational operation to expose such a capability as a resource. That resource may be discovered by an orchestration node, enabling the orchestration node to orchestrate execution of a complex computational operation using one or more computing nodes to execute component computational operations of the complex computational operation. As discussed above, according to some examples of the present disclosure, the complex computational operation, and the resource or resources exposed by a computing node or nodes, may be represented using the ONNX data format, and the orchestration node and computing node or nodes may comprise CoAP endpoints. There now follows a discussion of examples illustrating how the methods 100 to 400 may be implemented using the ONNX data format and communicating over CoAP.

It will be appreciated that while most of the terminology in the following discussion of example implementations is specific to CoAP and ONNX, some terms may be polysemic, and so the following discussion of terms is provided for the avoidance of doubt.

CoAP is a REST-based protocol that is largely inspired by HTTP and intended to be used in low-powered devices and networks, that is networks of very low throughput and devices that run on battery. Such devices often also have limited memory and CPU, such as the Class 1 devices set out in RFC 7228 as having 100KB of Flash and 10KB of RAM, but targeting environments with a minimum of 1.5KB of RAM.

CoAP Endpoints are usually devices that run at least a CoAP server, and often both a CoAP server and CoAP client. CoAP has its own set of Link Target Attributes (“rt=”, “if=”), content formats and other parameters registered in the Internet Assigned Numbers Authority (IANA).

Extensions to CoAP define elements that might be of use to devices. For example the Constrained RESTful Environments (CoRE) Resource Directory (RD), which contains information about resources held on other servers, allowing lookups to be performed for those resources. The input to an RD is composed of links, and the output is composed of links constructed from the information stored in the RD.

An endpoint in the following discussion thus refers to a CoAP Endpoint, that is a device running at least CoAP server and with some or all of the CoAP functionality. In the present example implementations, this endpoint can also run a subset of the ONNX operators. The capability to execute such an operator is exposed according to the present disclosure as any other RESTful resource would be.

There currently there exist two domains of ONNX operators: the ai.onnx domain for deep learning models, and the ai.onnx.ml domain for classical models. As ONNX has a focus on deep learning models, the ai.onnx domain has much larger set of operators (133 operators) than ai.onnx.ml. (18 operators). If a domain is not specified ai.onnx is assumed by default.

The operators set is not the only difference between classical and deep machine learning models in ONNX. Operators that are nodes of the ONNX computational graph can have multiple inputs and multiple outputs. For operators from the default deep learning domain, only dense tensor types for inputs and outputs are supported. Classical machine learning operators, in addition to supporting dense tensors, support sequence type and map type inputs. In the ONNX code base, the proto files for base structures of the model are available as regular textual files. For the operators, the case is different: operators are created programmatically, meaning that adding new operators or reviewing existing operators can be challenging. In theory it is possible to extended ONNX from the set of custom operators by defining a new operator set domain. In practice, at this time there are additional operator sets other than ai.onnx and ai.onnx.ml. For a machine learning library to support ONNX, it must be able to export and import ONNX models. Exporting means creating an ONNX file from a model in the library’s native format. Importing means loading and parsing an ONNX file into the library’s native format and using the model in the native format for inference.

A complete list of ONNX operators (ai.onnx) is provided at https://github.com/onnx/onnx/blob/master/docs/Operators.md. These operators include both primitive operations and compositions, which are often highly complex, of such primitive operations. Examples of primitive operations include ADD, AND, DIV, IF, MAX, MIN, MUL, NONZERO, NOT, OR, SUB, SUM, and XOR. A composition may comprise any combination of such primitive operations. A composition may be relatively simple, comprising only a small number of primitive operations, or may be highly complex, involving a large number of primitive operations that are combined in a specific order so as to perform a specific task. Compositions are defined for many frequently occurring tasks in implementation of ML models.

Examples of the present disclosure provide methods for orchestration of a complex computational operation, which complex computational operation may be decomposed into a plurality of component computational operations. The complex computational operation may for example comprise an ML model, or a chain of multiple ML models. The component computational operations, into which the complex computational operation may be decomposed, may comprise a mixture of primitive computational operations and/or combinations of primitive computational operations. The combinations may in some examples comprise compositions corresponding to operators of ML libraries or IRs such as ONNX, or may comprise other combinations of primitive operators that are not standardised in any particular ML framework.

The present disclosure proposes a specific content format to identify ONNX operators. This content format is named “application/onnx”, meaning that the resources exposed will be for ONNX applications and that the format will be .onnx, for the sake of the present example, the application/onnx content format is pre assigned the code 65056. An endpoint may therefore expose its capability to execute ONNX operators as resources under the path /onnx, in order to distinguish these capabilities from the physical properties of the device.

Interfaces for interaction with resources are defined using the “if=” link attribute, which can be used to specify properties of the endpoint that would facilitate interacting with it.

The present disclosure defines the interface onnx.rw for interfaces that admit all methods and onnx.r for those that only admit reading the output of the ONNX operations (i.e. the POST method is restricted).

As an example of the above discussed terms and definitions, if an entity were to query for all ONNX operators on a smart fridge, it would run:

REQ: GET coap://<fridge_ip>:5683/.well-known/core?ct=65056

This request asks for all resources having the content type defined above as corresponding to ONNX operators. If the fridge for example hosts the operators ADD, MUL, CONV, it would reply:

RES: 2.05 Content
</onnx/add>;rt=“addition”;if=“onnx.rw”,
</onnx/mul>;rt=“multiplication”;if=“onnx.rw”,
</onnx/conv>;rt=“convolution”;if=“onnx.rw”

As discussed above with reference to FIGS. 1 to 4b, examples of the present disclosure propose methods according to which an orchestrator node, which may be a computing device such as a constrained device which has been assigned an orchestrator role, to query the resources of a device or devices in a device cluster (e.g. business-related set of devices). These resources are exposed by the devices as capabilities to execute operations from a ML framework of the runtime of the device (for example, ONNX operators that are supported). The resources may be exposed by a restful protocol such as CoAP. The resources then become addressable and able to be reserved to be used to execute a ML model or a part of a ML model. An example implementation of the negotiation process to discover and secure the resources is summarized below.

During the initial discovery phase, the orchestrator node queries for computing nodes, which may be individual devices or devices in a cluster, that are able to execute component computational operations of a complex computational operation. The complex computational operation may be a ML model, represented according to the present implementation example using the ONNX format, or a collection of ML models which are chained together to perform a task. Each computing node (device or device cluster) shows their available operators by exposing the capabilities for their current runtime environment, using for example a resource directory and/or by replying to direct queries from authorised orchestrator node or nodes using any resource discovery method.

The orchestrator node then selects suitable computing devices and proceeds to contact them with a request to fulfil the execution of one or more component computational operations. The request may include a requirement for output throughput, as well as the characteristics of the input and the potential scheduling period for the execution (immediately, on demand, at 23:35, etc.). The request may also include a request for information about the computing node state (CPU load, memory load, I/O operation rates, connectivity bitrate, etc.)

The computing node or nodes evaluate the requests received from the orchestration node, and, based on their own configured policies (maximum amount of sharing CPU time, memory, availability of connectivity or concurrent offloading services etc.), and their state (current or estimated future state at time of scheduling). Then, according to computing node policies relating to execution offloading and sharing compatibility, the computing nodes return a response to the orchestration node. Computing node availability for multiple offloading requests from one or more orchestration nodes may also be considered in determining the response to be sent. In one example, if a computing node policy allows total sharing of resources, and the request from the orchestration node involves an “on demand” operation, the request may be granted. However, if the computing node policy only allows for full sharing during the evening hours, and an “on demand” request may be granted only between the hours of 18:00 and 06:00. If the request not compatible with computing node policy, it is rejected. The computing node may include additional information with a rejection response message, such as the expected throughput of the requested component computational operation and the state of the node.

On receiving a response from one or more computing nodes, the orchestration node may confirm the acceptance received from a computing node or may reject the acceptance.

The interaction model proposed according to examples of the present disclosure uses the defined ONNX operators set out above and enables ONNX-like interactions by using RESTful methods. The interaction model, using the CoAP methods, is as follows:
POST on operator implies that the POST will contain in the payload the data that needs to be processed (the input for the operator). The output of the POST can be 2.05 success with the result of the operation or one of the several CoAP error codes.
GET on operator implies that the orchestration node wishes to GET the result of the last operation on that operator.
PUT has the same effect as POST.
DELETE deletes the current state for that resource, thus deleting the last output of the operation.

For example an endpoint acting as orchestration node may ask another endpoint to perform a simple addition:

REQ: POST coap://<fridge_ip>:5683/onnx/add>
payload: <2,2>

The endpoint could then reply would reply:

RES: 2.05 Content
4

Another endpoint asking for the same resource at that time would then get the same result (important when designing distributed orchestration):

REQ: GET coap://<fridge_ip>:5683/onnx/add>
RES: 2.05 Content
4

Discovery of ONNX resources exposed by decentralised computing nodes can be carried out using the interaction model set out above.

CoAP-ONNX devices (that is computing nodes that are CoAP endpoints and have a capability to execute at least one ONNX operator) can make use of a Resource Directory to register their resources according to the CoAP functionality and using the new rt= and ct= for easier lookup.

A simple registration of the aforementioned smart fridge on “rd.home” would be:

REQ: POST coap://rd.home/rd?ep=fridge ct:40
</onnx/add>;ct=65056;rt=“addition”,
</onnx/mul>;ct=65056;rt=“multiplication”,
</onnx/conv>;ct=65056;rt=“convolution”

A simple lookup on “rd.home” could request all addition operations as follows:

REQ: GET coap://rd.home/rd-lookup/?rt=“addition”
RES: 2.05 Content
<coap://[2001:db8:3::123]/onnx/add>;rt=“addition”;
anchor=“coap://[2001:db8:3::123]:61616”

It will be appreciated that in many home automation deployments, all devices will be under the same subnet, including thermostat, refrigerator, television, light switches, and other home appliances having embedded processors that communicate over a local low-power network. This may enable the appliances to coordinate their behaviour without direct input from a user. A CoAP client can use UDP multicast to broadcast a message to every machine on the local network. CoRE has registered one IPv4 and one IPv6 address each for the purpose of CoAP multicast. All CoAP nodes can be addressed at 224.0.1.187 and at FF0X::FD. Nevertheless, multicast should be used with care as it is easy to create complex network problems involving broadcasting. A discovery for all CoAP endpoints using ONNX could be performed as follows:

REQ: GET coap://[FF0X::FD]/.well-known/core?ct=65056

Discussion of an example application for the present methods follows below.

The task is to train a model to predict if a food item in a fridge is still good to eat. The model is to be run in a distributed manner among home appliances (the fridge, a tv, lights etc.) and on any other device connected to a home network.

A set of photos of expired food is taken and passed to a convolutional neural network (CNN) that looks at images of food and is trained to predict if the food is still edible. It is assumed for the purposes of the present example that the training has already been completed, and the ML model spoiled-food.onnx is ready for use.

The model may use a limited number of operations, for example between 20 and 30, although for the present example only a small subset is considered for illustration. The operations for the ML model include ADD, MUL, CONV, bitshift and OR. None of the available appliances can execute all of them singlehandedly, and it is not desired to run the orchestrator on a computer or in the cloud. Instead it is chosen to run the model in a local-distributed fashion. The available endpoints expose the following resources:

lamp
∟/.well-known/core
∟/onnx
├ADD
∟OR
fridge
∟/.well-known/core
/onnx
├ADD
├MUL
∟CONV
tv
∟/.well-known/core
/onnx
├OR
├DIV
∟BITSHIFT

It is assumed that at least the appliances are on the home network, and that the resource directory and orchestrator node may or may not be on the home network.

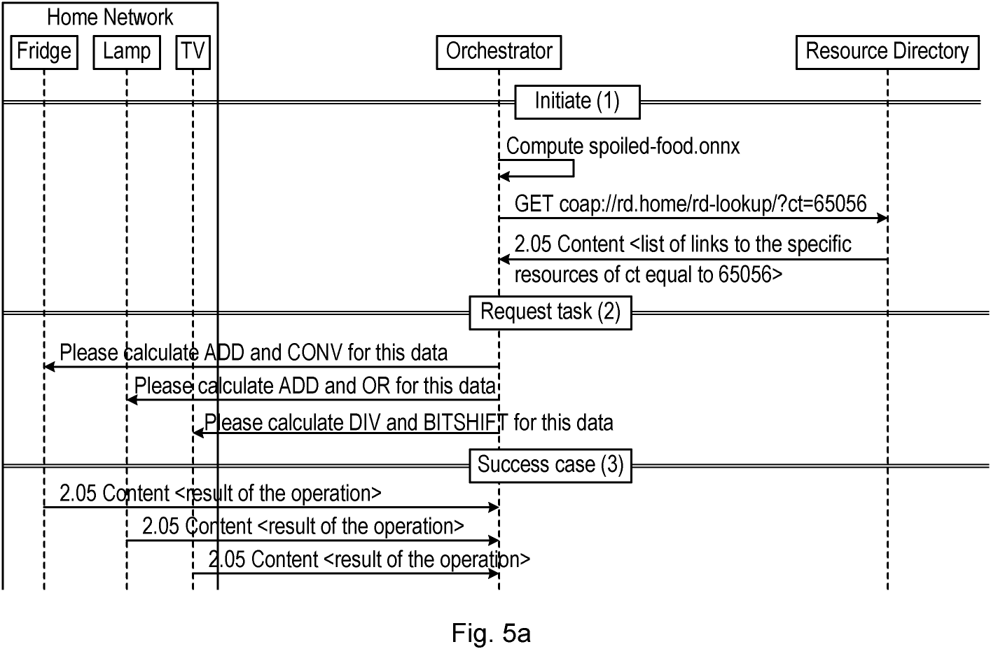

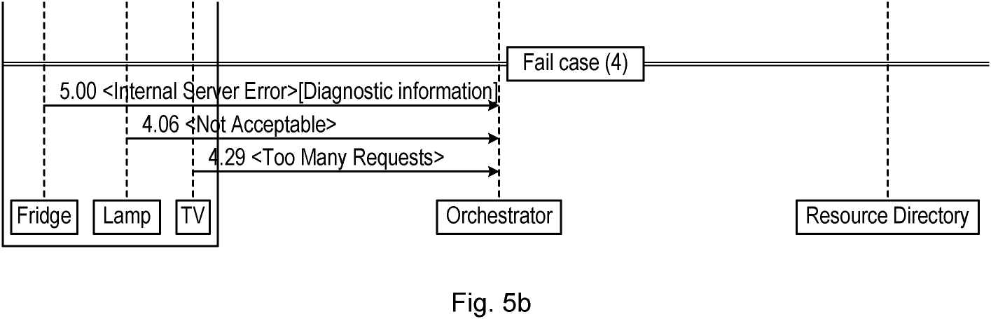

FIG. 5 illustrates the interactions to distribute the machine learning tasks among the various devices, using CoAP as application protocol that abstracts the resource controller functionality required according to the prior art. In FIG. 5, it is assumed that a computing node or device is acting as orchestration node (“Orchestrator”) and all devices are CoAP endpoints. The interactions in FIG. 5 involve a discovery process during which devices expose their capabilities to the Orchestrator, and an evaluation phase during which the Orchestrator estimates where to offload the execution. Devices then accept or reject the operations proposed by the Orchestrator. It is assumed that all devices are registered already on Resource Directory as explained above.

Referring to FIG. 5, the following steps may be performed.

In step 1, the Orchestrator initiates the operations by finding out which endpoints support ADD, MUL, CONV and BITSHIFT in order to calculate the CNN. The Orchestrator queries the Resource Directory to the lookup interface with the content type of application/onnx.

GET coap://rd.home/rd-lookup/?ct=65056

The query returns a list of links to the specific resources having a ct equal to 65056. As discussed above, the RD can also return interface descriptions and resource types that can help the Orchestrator to understand the functionality available behind a particular resource.

RES: 2.05 Content
<coap://[tv-ip]/core/onnx/add>;ct=65056;rt=“addition”;if=“onnx.rw”,
<coap://[tv-ip]/core/onnx/or>;ct=65056;rt=“or”;if=“onnx.rw”,
<coap://[fridge-
ip]/core/onnx/add>;ct=65056;rt=“addition”;if=“onnx.rw”,
<coap://[fridge-
ip]/core/onnx/mul>;ct=65056;rt=“multiplication”;if=“onnx.rw”,
<coap://[fridge-
ip]/core/onnx/conv>;ct=65056;rt=“convolution”;if=“onnx.rw”,
<coap://[lamp-ip]/core/onnx/or>;ct=65056;rt=“or”;if=“onnx.rw”,
<coap://[lamp-ip]/core/onnx/div>;ct=65056;rt=“division”;if=“onnx.rw”,
<coap://[lamp-
ip]/core/onnx/bitshift>;ct=65056;rt=“bitshift”;if=“onnx.rw”

The RD lookup can also allow for more complex queries. For example, an endpoint could query for devices that not only support ONNX but also are on battery and support the LwM2M protocol.

In LwM2M the battery information is stored on resource </3/0/9> and during registration such endpoint must do a POST with at least the following parameters:

</3/0/9>;rt=“lwm2m.battery”

With such a registration in place, the Orchestrator could query for devices that have a battery and that support ONNX with:

GET coap://rd.home/rd-lookup/res?rt=“lwm2m.battery”;ct=65056

If the Orchestrator wished to identify devices that not only have a battery but also have a battery life of more than 50%, the Orchestrator could use CoRAL (https://tools.ietf.org/html/draft-ietf-core-coral-02) instead of link-format and FETCH instead of GET:

FETCH coap://rd.home/rd-lookup/
<?x>
ct 65056
rt “lwm2m.battery”
representation {
numeric-gt 50
}

In step 2, once the Orchestrator has visibility over the endpoints that are capable of performing ONNX tasks, it enters the request phase in which it asks discovered devices to perform specific tasks, or computational operations using their exposed computational capabilities. In the example of FIG. 5, the Orchestrator uses the CoAP POST method as explained above. For example:

REQ: POST coap://<fridge_ip>:5683/onnx/add>
payload: <2,2>

The other operations are omitted for brevity.

The endpoints then can either accept the operation, operate and return a result (SUCCESS case) or they can reject it for various reasons (FAIL case).

For a SUCCESS case, in step 3, a device returns the result of the operation, in ONNX terminology this is called “output shape”.

RES: 2.05 Content
4

For a FAIL case, in step 4, the Orchestrator can either find another suitable device, or it may simply wait and repeat the request after some predefined time. Three example FAIL cases are provided below, illustrative of the flexibility of the implementation of the present methods using the CoAP protocol:
a. Internal Server error, over which diagnostic information related to the onnx application may be sent.
b. Not acceptable, if the content format for onnx is not available.
c. Too many requests, if the endpoint is busy at this point processing other requests.

Many other error codes may be envisioned, which error codes may be defined according to the onnx applications. Other reasons for request rejection may also be envisaged. For example the operation may be denied by the device as a result of insufficient throughput, or because of the characteristics of the input (i.e. input shape and actual input do not match), potential scheduling issues (the device is busy executing something else), etc.

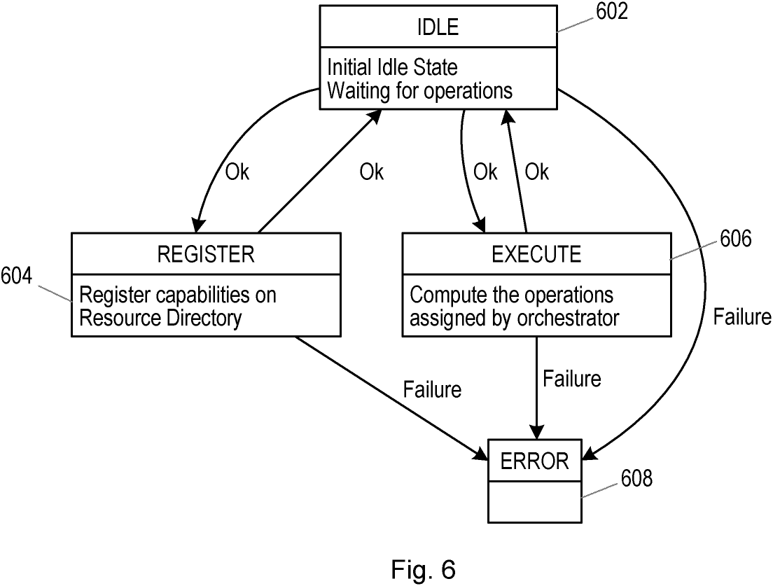

FIG. 6 is a state diagram for a computing node according to examples of the present disclosure. In an IDLE state 602, the computing node is waiting for a request to execute operations. The computing node may transition from the IDLE state 602 to a REGISTER state 604, in which the computing node registers its capabilities on a Resource Directory, and may transition from the REGISTER state 604 back to the IDLE state 602 once the capabilities have been registered. The computing node may also transition from the IDLE state 602 to an EXECUTE state 606 in order to compute operations assigned by an orchestration node. On completion of the operations, the computing node may transition back to the IDLE state 602. A failure in IDLE, REGISTER or EXECUTE states may transition the computing node to an ERROR state 608.

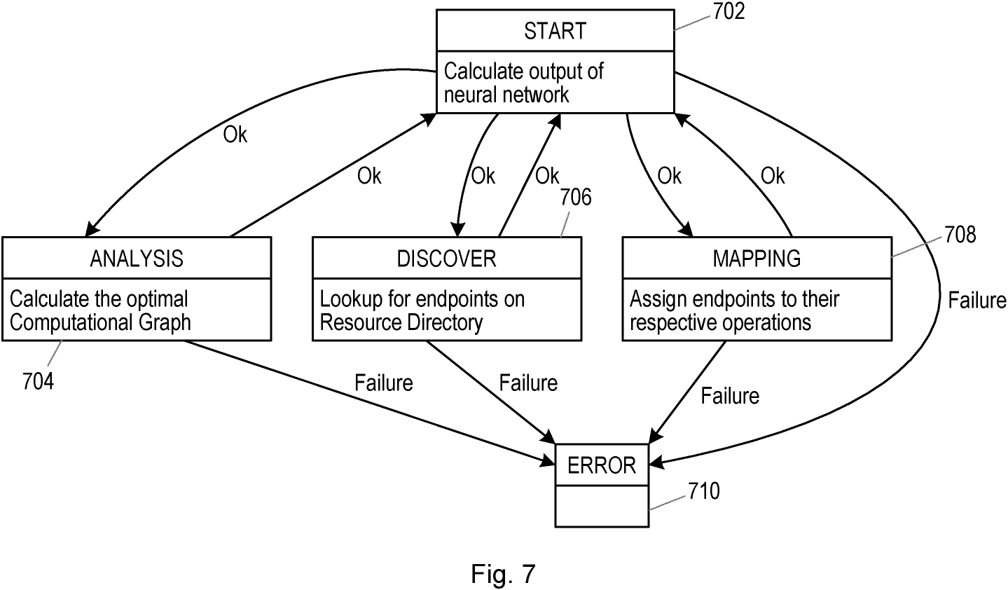

FIG. 7 is a state diagram for an orchestration computing node according to examples of the present disclosure. In a START state 702, the orchestration node obtains a complex computational operation (such as a ML model, neural network) to be calculated. The orchestration node may transition from the START state 702 to an ANALYSIS state 704, in which the orchestration node decomposes the complex computational operation, for example by calculating an optimal computation graph of the ML model. The orchestration node may transition from the ANALYSIS state 704 back to the START state 702 once the operation has been decomposed. The orchestration node may also transition from the START state 702 to a DISCOVER state 706 in order to discover computing nodes on a resource directory. On completion of discovery, the orchestration node may transition back to the START state 702. The orchestration node may also transition from the START state 702 to a MAPPING state 708 in order to assign computing nodes to operations and request execution. On completion of the execution of the operations, the orchestration node may transition back to the START state 702. A failure in START, ANALYSIS, DISCOVER or MAPPING states may transition the orchestration node to an ERROR state 710.

As discussed above, the methods 100, 200, 300 and 400 are performed by an orchestration node and a computing node respectively. The present disclosure provides an orchestration node and a computing node which are adapted to perform any or all of the steps of the above discussed methods. The orchestration node and/or computing node may comprise CoAP endpoints and may comprise constrained devices

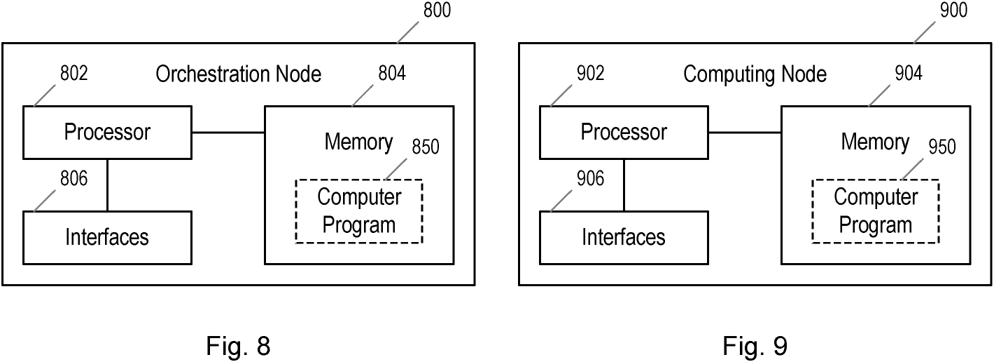

FIG. 8 is a block diagram illustrating an orchestration node 800 which may implement the method 100 and/or 200 according to examples of the present disclosure, for example on receipt of suitable instructions from a computer program 850. Referring to FIG. 8, the orchestration node 800 comprises a processor or processing circuitry 802, and may comprise a memory 804 and interfaces 806. The processing circuitry 802 is operable to perform some or all of the steps of the method 100 and/or 200 as discussed above with reference to FIGS. 1 and 2. The memory 804 may contain instructions executable by the processing circuitry 802 such that the orchestration node 800 is operable to perform some or all of the steps of the method 100 and/or 200. The instructions may also include instructions for executing one or more telecommunications and/or data communications protocols. The instructions may be stored in the form of the computer program 850. The interfaces 806 may comprise one or more interface circuits supporting wired or wireless communications according to one or more communication protocols. The interfaces 806 may support exchange of messages in accordance with examples of the methods disclosed herein. In one example, the interfaces 806 may comprise a CoAP interface towards a Resource Directory function and other CoAP interfaces towards computing nodes in the form of CoAP endpoints.

FIG. 9 is a block diagram illustrating a computing node 900 which may implement the method 300 and/or 400 according to examples of the present disclosure, for example on receipt of suitable instructions from a computer program 950. Referring to FIG. 9, the computing node 900 comprises a processor or processing circuitry 902, and may comprise a memory 904 and interfaces 906. The processing circuitry 902 is operable to perform some or all of the steps of the method 300 and/or 400 as discussed above with reference to FIGS. 3 and 4. The memory 904 may contain instructions executable by the processing circuitry 902 such that the computing node 900 is operable to perform some or all of the steps of the method 300 and/or 400. The instructions may also include instructions for executing one or more telecommunications and/or data communications protocols. The instructions may be stored in the form of the computer program 950. The interfaces 906 may comprise one or more interface circuits supporting wired or wireless communications according to one or more communication protocols. The interfaces 906 may support exchange of messages in accordance with examples of the methods disclosed herein. In one example, the interfaces 906 may comprise a CoAP interface towards an orchestration node, and may further comprise one or more CoAP interfaces towards other computing nodes in the form of CoAP endpoints.

In some examples, the processor or processing circuitry 802, 902 described above may include one or more microprocessors or microcontrollers, as well as other digital hardware, which may include digital signal processors (DSPs), special-purpose digital logic, etc. The processor or processing circuitry 802, 902 may be implemented by any type of integrated circuit, such as an Application Specific Integrated Circuit (ASIC), Field Programmable Gate Array (FPGA) etc. The memory 804, 904 may include one or several types of memory suitable for the processor, such as read-only memory (ROM), random-access memory, cache memory, flash memory devices, optical storage devices, solid state disk, hard disk drive etc.

Examples of the present disclosure provide a framework for exposing computation capabilities of nodes. Examples of the present disclosure also provide methods enabling the orchestration of machine learning models and operations in constrained devices without needing a resource controller. In some examples, the functionality of a resource controller is abstracted to the protocol layer of a transfer protocol such as CoAP. Also disclosed are an interaction model and the exposure, registration and lookup mechanisms for an orchestration node.

Examples of the present disclosure enable the negotiation of capabilities and operations for constrained devices involved in ML operations, allowing an orchestrator to distribute computation among multiple devices and reuse them over time. The negotiation procedures described herein do not have high requirements in terms of bandwidth or computation, nor do they require significant data sharing between endpoints, so lending themselves to implementation in a constrained environment. Examples of the present disclosure thus offer flexibility to dynamically execute ML operations that might be required as part of a high-level functional goal requiring ML implementation. This flexibility is offered without requiring an orchestrator to be preconfigured with knowledge of what is supported by each node and without requiring implementation of resource controller functionality in each of the nodes that are being orchestrated.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. An orchestration node which comprises a Constrained Application Protocol, CoAP, endpoint and which is operable to orchestrate execution of a complex computational operation by at least one computing node, which complex computational operation can be decomposed into a plurality of component computational operations, the orchestration node comprising processing circuitry that is configured to:
discover at least one computing node which comprises a CoAP endpoint and which has exposed, as a resource, a capability of the computing node to execute at least one component computational operation of the plurality of component operations ;
for each component computational operation of the complex computational operation, select a discovered computing node for execution of the component computational operation;
send a request message to each selected computing node requesting the selected computing node execute the component computational operation for which it has been selected; and
check for a response to each sent request message.

2-13. (canceled)

14. An orchestration node as claimed in claims 1, wherein the processing circuitry is further configured to apply an orchestration policy to select a discovered computing node for execution of a component computational operation, wherein the orchestration policy distinguishes between discovered computing nodes on the basis of at least one of:
information about a state of the discovered computing nodes;
information about a runtime environment of the discovered computing nodes; or
information about availability of the discovered computing nodes.

15-18. (canceled)

19. An orchestration node as claimed in claim 1, wherein the processing circuitry is further configured to send a request message to the selected computing node requesting the selected computing node to execute the component computational operation for which it has been selected by:
sending a CoAP POST REQUEST message or sending a CoAP PUT REQUEST message (230c).

20-21. (canceled)

22. A computing node which comprises a Constrained Application Protocol, CoAP, endpoint and which is operable to execute at least one component computational operation; the computing node comprising processing circuitry that is configured to:
expose, as a resource, a capability of the computing node to execute the at least one component computational operation;
receive a request message from an orchestration node which comprises a CoAP endpoint, the request message requesting the computing node execute a component computational operation;
determine whether execution of the requested component computational operation is compatible with an operating policy of the computing node; and
send a response message to the orchestration node.

23. A computing node as claimed in claim 22, wherein the capability of the computing node to execute the at least one component computational operation is represented using a data format.

24-25. (canceled)

26. A computing node as claimed in, claim 22, wherein the processing circuitry is further configured to expose the capability of the computing node to execute the at least one component computational operation by performing at least one of:
registering the capability as a resource with a resource directory function; or
receiving a discovery message requesting identification of computing nodes that have exposed a resource comprising a capability of the computing node to execute a component computational operation, and responding to the discovery message with an identification of the computing node and the capability.

27. A computing node as claimed in claim 26, wherein the processing circuitry is further configured to register the capability as a resource with a resource directory function by registering at least one of a content type of the resource, the content type corresponding to resources comprising a capability to execute a component computational operation, or a resource type of the resource, the resource type corresponding to the capability.

28. A computing node as claimed in claim 27, wherein the processing circuitry is further configured to:
receive a discovery message requesting identification of computing nodes that have exposed a resource comprising a capability of the computing node to execute a component computational operation and including in the discovery message at least one condition to be fulfilled by computing nodes;
determine whether the computing node fulfils the at least one condition included in the discovery message; and
respond to the discovery message with an identification of the computing node and the capability if the computing node fulfils the at least one condition.

29. A computing node as claimed in claim 26, wherein the discovery message is addressed to a multicast address for computing nodes.

30. A computing node as claimed in claim 22, wherein the request message includes at least one request parameter comprising at least one of:
a required output characteristic of the requested component computational operation;
an input characteristic of the requested component computational operation; or
a scheduling parameter for the requested component computational operation;
and wherein the processing circuitry is further configured to determine whether execution of the requested component computational operation is compatible with an operating policy of the computing node by determining at least one of:
whether the computing node is able to comply with the request parameter; or
whether compliance with the request parameter is compatible with an operating policy of the computing node.

31. A computing node as claimed in claims 22, wherein the request message includes a request for information about a state of the computing node, and wherein the processing circuitry is further configured to include the requested information with the response message.

32. A computing node as claimed in claims 22, wherein the processing circuitry is further configured to:
execute the requested component computational operation if execution of the requested computational operation is determined to be compatible with the operating policy of the computing node.

33. A computing node as claimed in claim 22, wherein the processing circuitry is further configured to send a response message that comprises at least one of:
acceptance of the requested component computational operation;
rejection of the requested component computational operation (441); or
a result of the requested component computational operation (443).

34. A computing node as claimed in claim 33, wherein acceptance of the requested execution of the component computational operation comprises at least one of partial or complete acceptance of the request message, and wherein partial acceptance comprises at least one of:
acceptance of the requested execution of the component computational operation that is conditional upon at least one criterion specified by the computing node; or
acceptance of the requested execution of the component computational operation that indicates that the selected computing node cannot fully comply with at least one request parameter included with the request message.

35. A computing node as claimed in claim 34, wherein the processing circuitry is further configured to receive from the orchestration node at least one of:
a confirmation message maintaining the request to execute the computational operation; or
a rejection message revoking the request to execute the computational operation.

36. A computing node as claimed in claims 22, wherein the processing circuitry is further configured to receive a request message from the orchestration node by:
receiving a CoAP POST REQUEST message or receiving a CoAP PUT REQUEST message.

37. A computing node as claimed in claim 22, wherein the processing circuitry is further configured to receive a request message from the orchestration node by receiving a CoAP GET REQUEST message; and to include in the response message to the orchestration node a result of the most recent execution of the requested component computational operation.

38. A computing node as claimed in claim 22, wherein the processing circuitry is further configured to expose the capability by:
receiving a CoAP GET REQUEST message or receiving a CoAP FETCH REQUEST message; and
responding to the received CoAP GET REQUEST message or CoAP FETCH REQUEST message.

39. A method for orchestrating execution of a complex computational operation by at least one computing node which comprises a Constrained Application Protocol, CoAP, endpoint, and wherein the complex computational operation can be decomposed into a plurality of component computational operations, the method, performed by an orchestration node which comprises a CoAP endpoint, comprising:
discovering at least one computing node that has exposed, as a resource, a capability of the computing node to execute at least one component computational operation of the plurality of component operations;
for each component computational operation of the complex computational operation, selecting a discovered computing node for execution of the component computational operation;
sending a request message to each selected computing node requesting the selected computing node execute the component computational operation for which it has been selected; and
checking for a response to each sent request message.

40. (canceled)

41. A method for operating a computing node which comprises a Constrained Application Protocol, CoAP, endpoint and which is operable to execute at least one component computational operation, the method, performed by the computing node, comprising:
exposing, as a resource, a capability of the computing node to execute the at least one component computational operation;
receiving a request message from an orchestration node which comprises a CoAP endpoint, the request message requesting the computing node execute a component computational operation;
determining whether execution of the requested component computational operation is compatible with an operating policy of the computing node; and
sending a response message to the orchestration node.

42-45. (canceled)
